(19) United States
(12) Patent Application Publication
(10) Pub. No.: US 2025/0128299 A1
(43) Pub. Date: Apr. 24, 2025

(54) CONTAMINANT REMOVAL APPARATUS AND METHODS FOR TAPE AND REEL CARRIER TAPE

(71) Applicant: Skyworks Solutions, Inc., Irvine, CA (US)

(72) Inventors: Edgar Antonio Martinez Silva, Mexicali (MX); Raul Jacobo Cazares, Mexicali (MX); Aldo Lobatos Almejo, Mexicali (MX); Daniel Orozco Mariscal, Mexicali (MX)

(21) Appl. No.: 18/920,023

(22) Filed: Oct. 18, 2024

Related U.S. Application Data
(60) Provisional application No. 63/544,931, filed on Oct. 19, 2023.
(60) Provisional application No. 63/544,933, filed on Oct. 19, 2023.

(51) Int. Cl. B08B 5/04; B08B 5/02; B08B 7/00

(52) U.S. Cl. CPC B08B 5/046; B08B 5/026; B08B 7/00

(57) ABSTRACT

A method of cleaning a tape and reel carrier tape by unspooling a tape and reel carrier tape from a first reel and onto a second reel. As the tape and reel carrier tape travels from the first reel to the second reel, the method includes passing the tape and reel carrier tape through an inner chamber of a contaminant removal apparatus, and removing contaminants from the tape and reel carrier tape by circulating air within an inner chamber of the contaminant removal apparatus.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

The disclosure relates to methods and apparatus for packaging electronic components, including tape and reel packaging of electronic modules including integrated circuits.

Carrier reel tape is used to transport and protect electronic components during shipping. Contaminants have been known to enter the carrier reel tape during the packaging process. There is a need to reduce contamination.

### SUMMARY

In some aspects, the techniques described herein relate to a method of cleaning a tape and reel carrier tape including: unspooling a tape and reel carrier tape from a first reel and onto a second reel; as the tape and reel carrier tape travels from the first reel to the second reel, passing the tape and reel carrier tape through an inner chamber of a contaminant removal apparatus; and removing contaminants from the tape and reel carrier tape by circulating air within an inner chamber of the contaminant removal apparatus.

In some aspects, the techniques described herein relate to a method wherein the removing contaminants is performed using a fluid pump.

In some aspects, the techniques described herein relate to a method wherein the fluid pump is a compressor.

In some aspects, the techniques described herein relate to a method wherein the passing the tape and reel carrier tape through the inner chamber includes guiding the tape and reel carrier tape into the inner chamber through a first opening of a housing of the contaminant removal apparatus and out of the inner chamber through a second opening of the housing of the contaminant removal apparatus.

In some aspects, the techniques described herein relate to a method further including adjusting a tape width adjustment mechanism within the inner chamber to accommodate a width of the tape and reel carrier tape.

In some aspects, the techniques described herein relate to a method further including fluidly connecting a venturi valve to the inner chamber.

In some aspects, the techniques described herein relate to a method wherein the venturi valve is connected between a compressor and the inner chamber.

In some aspects, the techniques described herein relate to a method further including, prior to unspooling the tape and reel carrier tape: placing integrated circuit components into pockets of the tape and reel carrier tape; and spooling the tape and reel carrier tape onto the first reel.

In some aspects, the techniques described herein relate to a method of removing contaminants from a tape and reel carrier tape, the method including: feeding the tape and reel carrier tape to a contaminant removal apparatus through a first opening in a housing of the contaminant removal apparatus; removing contaminants from the tape and reel carrier tape by circulating air within an inner chamber of the contaminant removal apparatus; and feeding the tape and reel carrier tape out of the contaminant removal apparatus through a second opening in the housing of the contaminant removal apparatus.

In some aspects, the techniques described herein relate to a method further including inserting a component into a pocket of the tape and reel carrier tape prior to the tape and reel carrier tape entering the first opening.

In some aspects, the techniques described herein relate to a method further including unspooling the tape and reel carrier tape from a first carrier reel into the first opening.

In some aspects, the techniques described herein relate to a method further including spooling the tape and reel carrier tape from the second opening onto a second carrier reel.

In some aspects, the techniques described herein relate to a method wherein the removing contaminants is performed using a fluid pump.

In some aspects, the techniques described herein relate to a method further including adjusting a tape width adjustment mechanism within the inner chamber to accommodate a width of the tape and reel carrier tape.

In some aspects, the techniques described herein relate to a method further including fluidly connecting a venturi valve to the inner chamber.

In some aspects, the techniques described herein relate to a method wherein the venturi valve is connected between a compressor and the inner chamber.

In some aspects, the techniques described herein relate to a carrier tape contaminant removal apparatus including: a housing having an inner chamber; a first carrier tape opening formed in a first side of the housing; a second carrier tape opening formed in a second side of the housing that opposes the first side of the housing, the first carrier tape opening and the second carrier tape opening dimensioned to allow passage of a tape and reel carrier tape such that the tape and reel carrier tape enters the inner chamber of the housing via the first carrier tape opening and exits via the second carrier tape opening; and a port formed in the housing and adapted to connect to a fluid pump, to allow the fluid pump to be fluidly connected to the inner chamber of the housing.

In some aspects, the techniques described herein relate to a carrier tape contaminant removal apparatus wherein the fluid pump is a vacuum or a compressor.

In some aspects, the techniques described herein relate to a carrier tape contaminant removal apparatus wherein the housing is substantially rectangular in shape.

In some aspects, the techniques described herein relate to a carrier tape contaminant removal apparatus wherein the first carrier tape opening, and the second carrier tape opening are elongate slits.

In some aspects, the techniques described herein relate to a carrier tape contaminant removal apparatus further including an adjustment mechanism within the inner chamber and configured to move upon user adjustment to accommodate different carrier tapes of different widths passing through the inner chamber.

In some aspects, the techniques described herein relate to a carrier tape contaminant removal apparatus further including a valve fluidly connected between the fluid pump and the port.

In some aspects, the techniques described herein relate to a carrier tape contaminant removal apparatus wherein the valve includes a Venturi Valve.

In some aspects, the techniques described herein relate to a carrier tape contaminant removal apparatus further including a cut-off valve fluidly connected between the fluid pump and the port.

In some aspects, the techniques described herein relate to a carrier tape contaminant removal apparatus further including a regulator fluidly connected between the fluid pump and the port.

In some aspects, the techniques described herein relate to a tape and reel apparatus including: a frame; a first reel supported by the frame and configured to unspool a carrier tape; a second reel supported by the frame and configured to spool the carrier tape; a contaminant removal apparatus positioned between the first reel and the second reel and including a housing having an inner chamber, a first opening formed in a first side of the housing, a second opening formed in a second side of the housing, the first opening and the second opening dimensioned to allow passage of the carrier tape such that the carrier tape enters the inner chamber of the housing after being unspooled from the first reel via the first opening and exits via the second opening for spooling onto the second reel, and the contaminant removal apparatus further including a port formed in the housing and adapted to connect to a fluid pump, to allow the fluid pump to be fluidly connected to the inner chamber of the housing.

In some aspects, the techniques described herein relate to a tape and reel apparatus wherein the fluid pump is a vacuum or a compressor.

In some aspects, the techniques described herein relate to a tape and reel apparatus wherein the housing is substantially rectangular in shape.

In some aspects, the techniques described herein relate to a tape and reel apparatus wherein the first opening and the second opening are elongate slits.

In some aspects, the techniques described herein relate to a tape and reel apparatus further including an adjustment mechanism within the inner chamber and configured to move upon user adjustment to accommodate different carrier tapes of different widths passing through the inner chamber.

In some aspects, the techniques described herein relate to a tape and reel apparatus further including a valve fluidly connected between the fluid pump and the port.

In some aspects, the techniques described herein relate to a tape and reel apparatus wherein the valve includes a Venturi Valve.

In some aspects, the techniques described herein relate to a tape and reel apparatus further including a cut-off valve fluidly connected between the fluid pump and the port.

In some aspects, the techniques described herein relate to a tape and reel apparatus further including a regulator connected between the fluid pump and the port.

### BRIEF DESCRIPTION OF THE DRAWINGS

FIGS. 1A-1B are perspective and front side view illustrations of a tape and reel station including a contaminant removal apparatus according to some embodiments.

FIG. 1C is a top-down view illustrating a portion of the tape and reel station of FIGS. 1A-1B.

FIGS. 1D-1E are rear-perspective and side views of the contaminant removal apparatus of the tape and reel station of FIGS. 1A-1B.

FIG. 1F is a front-side view illustration of a portion of the tape and reel station of FIGS. 1A-1B.

FIG. 2 is a front perspective view of another embodiment of a tape and reel station.

FIG. 3 is a perspective schematic view of a contaminant removal apparatus showing airflow within an inner chamber of the apparatus according to certain embodiments.

FIG. 4A is a left-side view illustration of a contaminant removal apparatus according to some embodiments.

FIG. 4B is a right-side view illustration of a contaminant removal apparatus according to some embodiments.

FIGS. 5A-5B illustrate examples of a carrier tape according to certain embodiments.

### DETAILED DESCRIPTION

Tape and reel carriers are used in packaging and shipping electronic components and devices. This type of packaging allows automated component placement, smaller package size, and cost savings. For example, placement machines can pick and place thousands of components per hour into the carrier tape with a very high degree of accuracy. This allows feeding parts at high speeds in a consistent orientation, positively indexed to the carrier tape. Tape and reel packaging can protect the leads of electronic components from damage during shipment, handling, and placement. De-taping equipment is used in coordination with automated placement equipment to quickly and efficiently remove individual components from the carrier tape.

When utilizing a tape and reel process, components can be placed in specifically designed pockets embossed in a plastic carrier tape. The cover tape is typically sealed to the carrier tape to keep the parts in place in these pockets. A row of sprocket holes is provided along one edge of the embossed tape to facilitate positive indexing. The tape is then wound onto a rigid plastic reel that provides mechanical protection during handling and storage. These reels are dust-free and compatible with a clean environment. Carrier tape is also known to provide a high degree of protection from electrostatic discharge (ESD) and are static-dissipative. Reels are typically shipped in moisture barrier bags, a box with ESD conductive coating, and/or in a conductive ESD bag. Due to the level of packaging, reels are typically opened only at ESD workstations by trained personnel.

Contamination can occur during the tape and reel process. For example, after components have been placed into the pockets of the carrier tape and before the cover tape is applied to seal the carrier tape, particles of dust or other contaminants have been known to infiltrate the pockets or otherwise be introduced onto the carrier tape or the components carried by the carrier tape. Or such contaminants can be introduced after the cover tape is applied to the carrier tape. Thus, a need exists for packaging carrier tape while preventing the introduction of contaminants prior to shipping reeled carrier tape, e.g., prior to placing the reels in the moisture barrier bag, ESD box and/or ESD bag. In addition, a need exists for removing contaminants during an unpacking stage, to remove particles that entered the pockets during the packaging phase and/or prevent contaminants from entering pockets after unpacking and/or removing the sealing tape.

A contaminant removal apparatus resolves these and other problems by removing contaminants from the carrier tape. Carrier tape is fed through the apparatus which removes contaminants through the flow or circulation of gas such as air, oxygen, nitrogen, argon, and/or hydrogen. The circulating gas removes dust, debris, and other contaminants. For example, the contaminants can either be expelled through openings in the contaminant removal apparatus or through one or more tubes (i.e. hoses) fluidly attached to the contaminant removal apparatus.

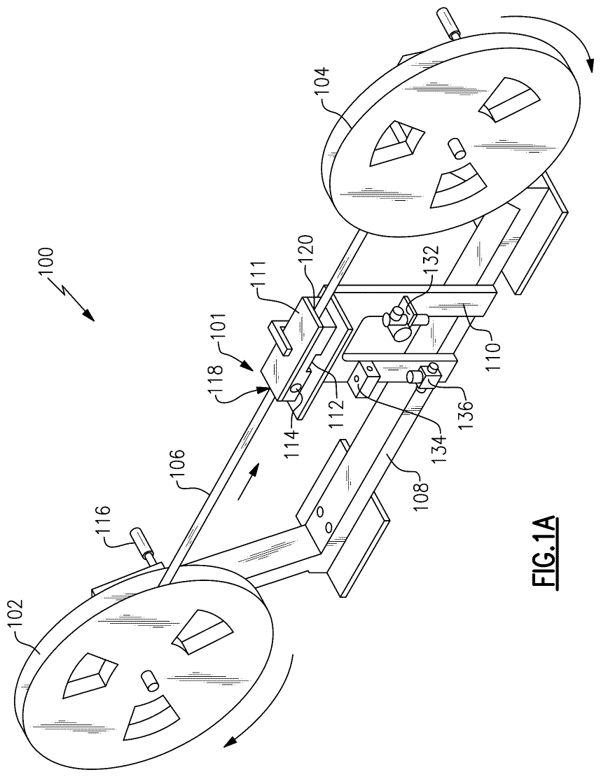

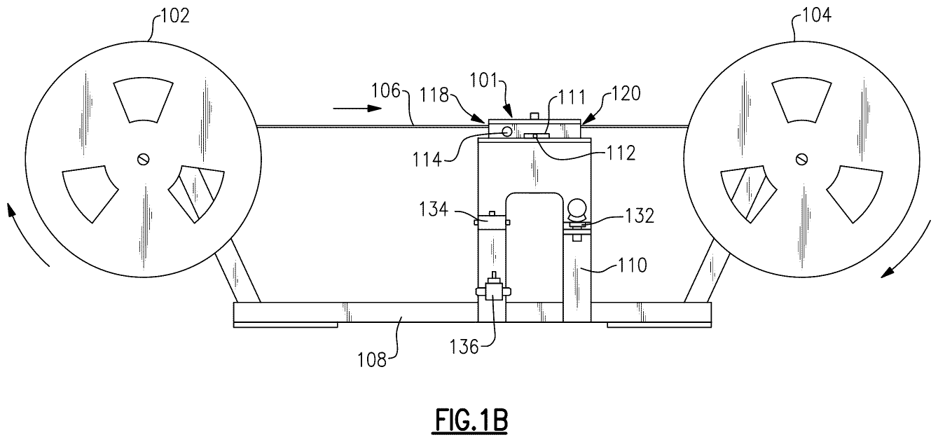

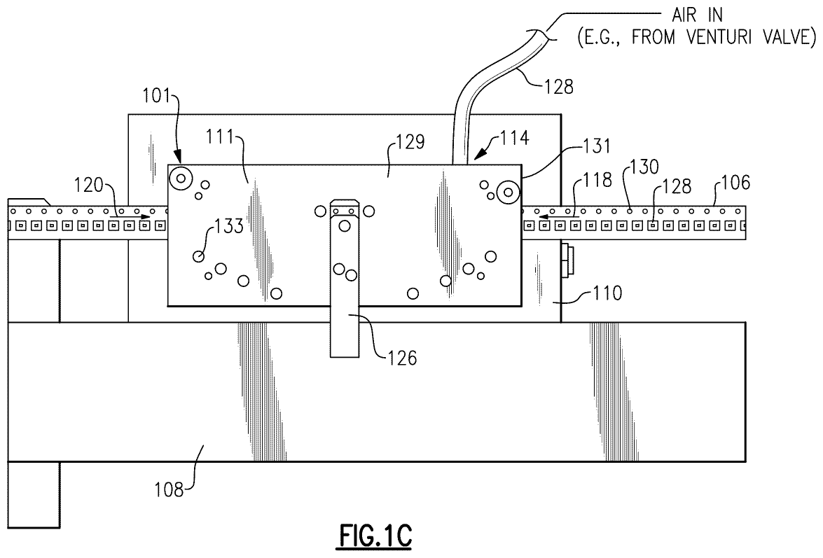

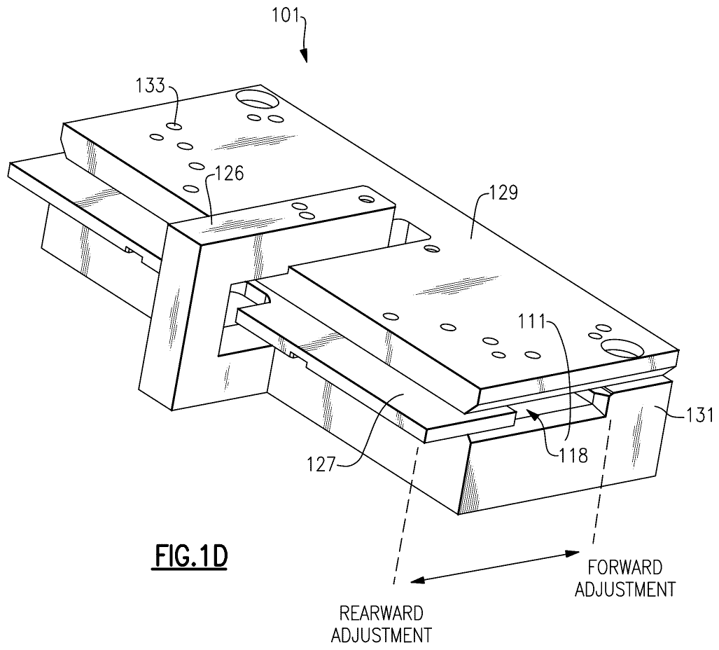

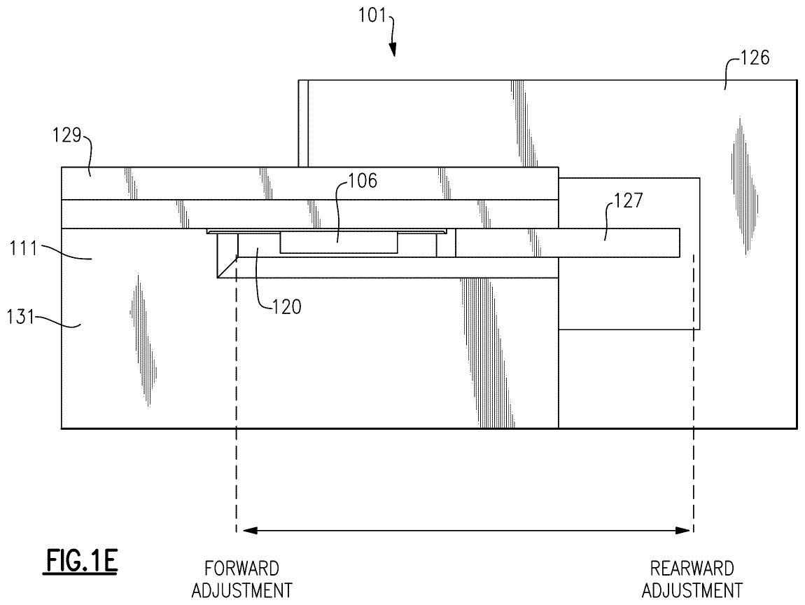

FIGS. 1A and 1B show perspective and front side views of an example embodiment of a tape and reel station 100.

The tape and reel sealing station 100 includes a frame 108, a first reel 102, a second reel 104, carrier tape 106, a stand 110, and a contaminant removal apparatus 101. The contamination removal apparatus 101 can comprise a housing 111 with an inner chamber (not shown) and a port 114 in fluidic communication with the inner chamber. Although not shown in FIGS. 1A-1B to simplify the illustration, a hose (see, e.g., FIG. 1F) can be connected to the port 114 to allow for fluidic communication with the inner chamber of the housing 111, to facilitate airflow into the chamber to facilitate removal of particles/contaminants that may be present on the tape 106 as it passes through the inner chamber.

The first reel 102 and second reel 104 are rotatably attached to the frame 108. The first reel 102 contains spooled carrier tape 106. The carrier tape 106 on the first reel 102 may be empty or it may contain electronic components (e.g., packaged modules including one or more semiconductor integrated circuit dies and/or other componentry) inside pockets on the tape (not shown in FIG. 1A). The carrier tape 106 extends from the first reel 102 where it is unspooled, to the second reel 104 where it is spooled. As shown, both reels rotate in a clockwise motion causing the carrier tape 106 to move away from the first reel 102 and toward the second reel 104. In some embodiments, the first reel 102 and second reel 104 may be rotated manually by a user using the handle 116. In some embodiments, the reels may be rotated automatically when connected to a motor.

In the illustrate embodiment, the stand 110 is attached to the frame 108 and positioned vertically between the first reel 102 and second reel 104. The contaminant removal apparatus 101 is attached to the frame 108 and elevated to intersect the path of the carrier tape 106 as it travels between reels. Before the carrier tape 106 is spooled onto the second reel 104 it passes into the inner chamber of the housing 111 of the contaminant removal apparatus 101 via a first opening 118 on the left side of the housing 111 and out of the inner chamber via a second opening 120 on the right side of the housing 111, thereby allowing the removal apparatus 101 to remove contaminants from the carrier tape 106 and from each component as each component passes through inner chamber.

In some embodiments, the contaminant removal apparatus 101 or another part of the sealing station 100 can include a sealer to seal the pockets closed in addition to removing contaminants. For example, a mechanism can be included for applying a sealing tape to the carrier tape 106, such that sealing tape is applied to portions of the carrier tape 106 after those portions have passed through the inner chamber.

FIG. 1C is a top-down view of a portion of the tape and reel station 100 of FIGS. 1A-1B and shows the contaminant removal apparatus 101. As shown, the port 114 is attached to a hose 128. The hose 128 can be fluidly attached to one or more fluid pumps (not shown in FIG. 1C). Moreover, a gas can be provided to or from the housing 111 via the hose 128 by the fluid pump(s) or other mechanism via the hose 128. The gas can include air, oxygen, nitrogen, argon, and/or hydrogen. For example, as is shown and discussed in detail with respect to FIG. 1F, the hose 128 can be connected to an air compressor via a series of other hose segments 122, 124, 126 and other components, such as a regulator 132, a cut-off valve 136, and/or a Venturi valve 134. The compressor connection can be a compressor line on a factory floor.

FIG. 1C also illustrates the carrier tape 106 in more detail by showing the individuated components 128 and the sprocket holes 130 that facilitate feeding of the carrier tape 106.

The contaminant removal apparatus can be adjustable to accommodate different widths of the carrier tape 106. FIGS. 1D-1E are rear-perspective and side views of the contaminant removal apparatus of the tape and reel station of FIGS. 1A-1B and show the adjustment mechanism in detail. As indicated by the arrows in FIGS. 1D-1E, the adjustable member 127 can be adapted to be moved by a user forward to accommodate smaller tape widths or backward to accommodate larger tape widths, by decreasing and increasing the width of the first and second openings 118, 120 that provide access to the tape slot. In some cases, the user can insert pegs in the appropriate hole(s) 133 provided in the top plate. The user can move the adjustable member 127 up against the pegs, to set the tape slot to the desired width.

The illustrated contaminant removal apparatus 101 also includes an adjustable laser holder 126. The laser holder 126 can accommodate mounting of a laser (not shown), which can be connected to a processor for optically counting or otherwise tracking the components 128 as they travel through the contaminant removal apparatus 101. For example, a laser can be mounted to the laser holder 126 such that laser emits a beam onto the portion of the tape beneath the laser holder 126 as the tape is fed through the tape slot and inner chamber of the contaminant removal apparatus 101.

FIG. 1F is a front-side view of a portion of the reel station 100 of FIGS. 1A-1C, and which shows the contaminant removal apparatus 101. As explained previously, the housing 111 includes a top plate 129 attached to a bottom piece 131, with a cavity defined by the bottom piece 131 and/or the top plate 129 to form the inner chamber. The top plate 129 can be sealed (e.g., welded, glued) to the bottom piece 131, or in other embodiments, the top plate 129 is removably coupled to the bottom piece 131 (e.g., via friction fit, screws, bolts, or other fasteners).

FIG. 1F shows an air regulator 132, a cut-off valve 136, and a Venturi valve 134 mounted to the stand 110. Air from a compressor (not shown) is delivered via a first hose segment 122 to an inlet of the air regulator 132. The air regulator 132 can be a pressure regulator that can adjust a pressure on the outlet of the air regulator 132 and/or maintain a constant pressure at the outlet of the air regulator 132. A second hose segment 124 extends from the outlet of the air regulator 132 to the inlet to the cut-off valve 136, which a user can control to stop or allow air flow to a third hose segment 126 attached to the outlet of the cut-off valve 136. The third hose segment 126 extends to an inlet of the Venturi Valve 134. The fourth hose segment 128 extends from an outlet of the Venturi Valve 134 to the port 114 of the contaminant removal apparatus 114. In this manner, the Venturi valve 134 can regulate and/or measure airflow within the inner chamber. The Venturi Valve 134 can be adjustable to allow the user to adjust the airflow or can provide a fixed airflow, depending on the embodiment. Other configurations are possible for creating airflow within the inner chamber of the housing 111. For example, in other embodiments, a vacuum pump can be connected to the port 114. In one alternative implementation, a compressor is attached to a first port to blow air into the inner chamber and a vacuum is attached to another port to suck air out of the inner chamber.

A method of cleaning a packaging carrier tape 106 may include placing components 128 in pockets of the carrier tape 106; spooling the carrier tape 160 onto the first reel 102 attached to the frame 108; unspooling the carrier tape 106 such as with one of the handles 116 while guiding the carrier tape 106 through the chamber of the contaminant removal apparatus 111 via the openings 118, 120; removing contaminants from the carrier tape and the components residing thereon as they pass through the chamber by blowing air into chamber via the port 114, thereby circulating air within the inner chamber; and spooling the contaminant-free portion of the carrier tape 106 onto the second reel 104.

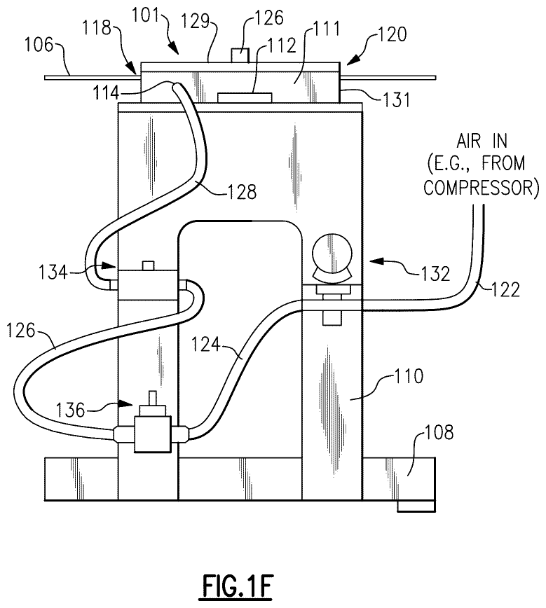

FIG. 2 is a perspective view of a tape and reel station according to another embodiment. The station includes a contaminant removal apparatus 201 supported by a stand 210 attached to a frame 208. A pair of reels 202, 204 can be attached to frame 208, such that the contaminant removal apparatus 201 can be disposed between the reels 202, 204, and a component tape (not shown in FIG. 2) can be spooled from one real to the other can be fed through the openings (only one opening 218 shown in FIG. 2) of the contaminant removal apparatus 201, like the apparatus 100 of FIG. 1A. Like the contaminant removal apparatus 101 of FIG. 1A, the contaminant removal apparatus 201 includes a housing 211 forming an internal chamber or cavity (not shown). Air or another gas can be supplied (e.g., via a compressor connected to a Venturi Valve) to the housing 211 via a hose connected to a port (not shown) that is in fluidic communication with the chamber, similar to the apparatus of FIG. 1A-1F, so as to allow air to blow on a component tape as it passes through the chamber.

In the embodiment of FIG. 2, the station includes a cover 240 enclosing the contaminant removal apparatus 201. The cover 240 is attached stand 210 via hinges to allow the cover 240 to swing open about the hinges.

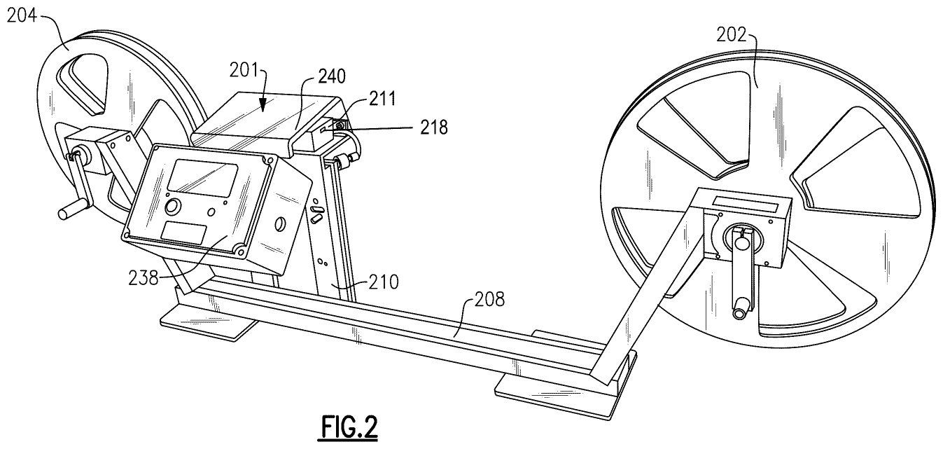

FIG. 3 is a perspective schematic view of a contaminant removal apparatus 301 showing airflow within an inner chamber of the apparatus according to certain embodiments. As illustrated by the dashed arrows, air enters the chamber (e.g., from a compressor) via the first hose 322 and first opening 312 and travels within the chamber to dislodge contaminants from the tape and/or components carried by the tape (not shown in FIG. 3) within the chamber. Air can exit the chamber via the openings 318, 320. In other embodiments, the housing 311 can include a second port providing access to the inner chamber, and air can exit via that second port instead of or in addition to the openings 318, 320.

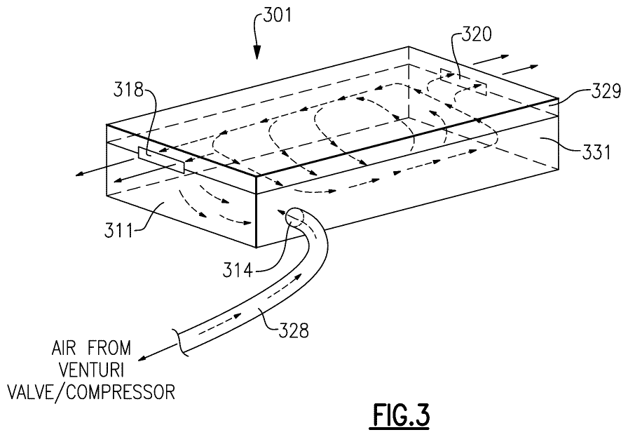

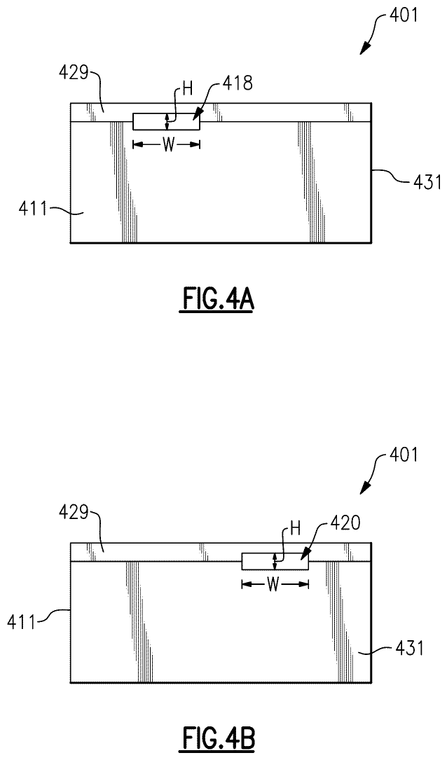

FIG. 4A is a left-side view of a contaminant removal apparatus 401. FIG. 4B is a right-side view of a contaminant removal apparatus 401, which may be the same as or similar to the contaminant removal apparatus 111 of FIGS. 1-3.

The contaminant removal apparatus 401 includes a housing 412. The housing 412 includes a top plate 418 attached to a bottom plate 420. A back side of the housing 412 may be fluidly connected to one or more fluid pumps (not shown).

A left side of the housing 411 includes a first opening 418. The first opening 418 is positioned between the top plate 429 and the bottom plate 431. A right side of the housing 411 includes a second opening 420. The second opening 420 is positioned between the top plate 429 and the bottom plate 431. An inner chamber is located within the housing 411 and positioned between the openings 418, 420.

The first opening 418 and second opening 420 are designed to allow a carrier tape to pass through. Here, the carrier tape (not shown) passes through the first opening 418 and into the inner chamber before passing through the second opening 420 and outside of the housing 411.

The first opening 418 and second opening 420 of the illustrated embodiment are rectangular in shape. In some embodiments, the openings may have another shape (e.g., circular, ovular, rectangular with rounded corners, or other have other polygon shapes). The openings 418, 420 have a height and a width adapted to accommodate the carrier tape. For example, in the illustrated embodiments the openings 422, 424 are rectangular slits having an adjustable width W, which can be adjusted to a size of up to about 24 mm using the adjustment member 127 to accommodate tapes having widths of up to about 24 mm. In other cases, the maximum size can be larger (e.g., 30 mm, 50 mm or larger). Depending on the embodiment, the adjustment member 127 can allow for continuous width adjustment, and/or adjustment in discrete steps, e.g., to accommodate 8 mm wide, 16 mm wide, or 24 mm wide tapes. In some embodiments, each opening is lined with a brush or wipe which is designed to contact the tape as it passes through.

The height and width of the openings can be intentionally larger than the dimensions of the carrier tape and allow gas to pass through. For example, when the pressure within the inner chamber is high, gases may pass through each aperture to an area outside the housing 412. When the pressure within the inner chamber is low than the outside pressure, gases may pass through each opening and into the inner chamber.

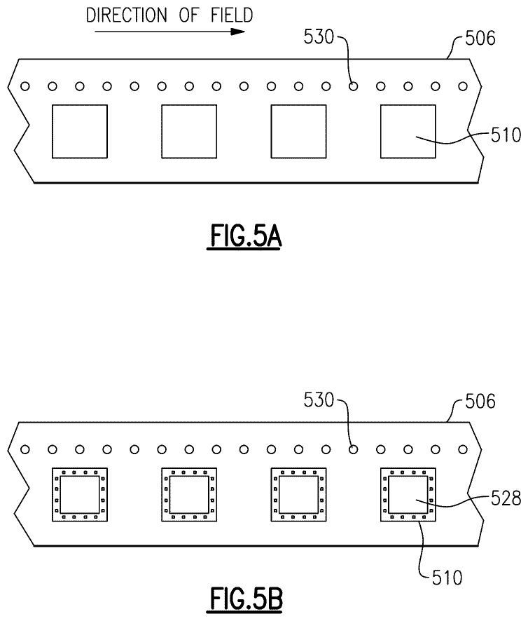

FIG. 5A is an illustration of an example of an empty carrier tape 506 containing recessed pockets 510. FIG. 5B shows the carrier tape 506 with electronic components 528 in the pockets 510. The components 528 can include, for example, packaged integrated circuit semiconductor dies, packaged modules including one or more semiconductor dies and other microelectronic componentry, or other types of components. The components 528 can be inserted into recessed pockets 510 of the carrier tape 506 at a specific orientation. Sprocket holes 530 can be used to align and advance the carrier tape 506 through automated pick-an-place machines and/or other machines, e.g., that place the electronic components 528 onto printed circuit boards. The carrier tape 506 is advanced in a feed direction. The machines use pins or rollers that engage with the sprocket holes 530 to precisely position the carrier tape 506, so that the components 528 are placed onto the circuit boards with the correct spacing and orientation. The sprocket holes 530 can be used to align and advance the carrier tape 506 through the contaminant removal apparatus.

The sprocket holes 530 can also be used to detect the presence of the carrier tape 506 and monitor its movement during the manufacturing process. Optical sensors or cameras can be used to detect the presence of the sprocket holes 530, pockets 510, and/or components 528, and thereby track the position of the carrier tape 506, ensuring that the components are 528 placed accurately and reliably.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

What is claimed is:

1. A carrier tape contaminant removal apparatus comprising:
a housing having an inner chamber;
a first carrier tape opening formed in a first side of the housing;
a second carrier tape opening formed in a second side of the housing that opposes the first side of the housing, the first carrier tape opening and the second carrier tape opening dimensioned to allow passage of a tape and reel carrier tape such that the tape and reel carrier tape enters the inner chamber of the housing via the first carrier tape opening and exits via the second carrier tape opening; and
a port formed in the housing and adapted to connect to a fluid pump, to allow the fluid pump to be fluidly connected to the inner chamber of the housing.

2. The carrier tape contaminant removal apparatus of claim 1 wherein the fluid pump is a vacuum or a compressor.

3. The carrier tape contaminant removal apparatus of claim 1 wherein the housing is substantially rectangular in shape.

4. The carrier tape contaminant removal apparatus of claim 1 wherein the first carrier tape opening, and the second carrier tape opening are elongate slits.

5. The carrier tape contaminant removal apparatus of claim 1 further comprising an adjustment mechanism within the inner chamber and configured to move upon user adjustment to accommodate different carrier tapes of different widths passing through the inner chamber.

6. The carrier tape contaminant removal apparatus of claim 1 further comprising a valve fluidly connected between the fluid pump and the port.

7. The carrier tape contaminant removal apparatus of claim 6 wherein the valve is a Venturi Valve.

8. The carrier tape contaminant removal apparatus of claim 1 further comprising a cut-off valve fluidly connected between the fluid pump and the port.

9. The carrier tape contaminant removal apparatus of claim 1 further comprising a regulator fluidly connected between the fluid pump and the port.

10. A tape and reel apparatus comprising:
a frame;
a first reel supported by the frame and configured to unspool a carrier tape;
a second reel supported by the frame and configured to spool the carrier tape;
a contaminant removal apparatus positioned between the first reel and the second reel and including a housing having an inner chamber, a first opening formed in a first side of the housing, a second opening formed in a second side of the housing, the first opening and the second opening dimensioned to allow passage of the carrier tape such that the carrier tape enters the inner chamber of the housing after being unspooled from the first reel via the first opening and exits via the second opening for spooling onto the second reel, and the contaminant removal apparatus further including a port formed in the housing and adapted to connect to a fluid pump, to allow the fluid pump to be fluidly connected to the inner chamber of the housing.

11. The tape and reel apparatus of claim 10 wherein the fluid pump is a vacuum or a compressor.

12. The tape and reel apparatus of claim 10 further comprising an adjustment mechanism within the inner chamber and configured to move upon user adjustment to accommodate different carrier tapes of different widths passing through the inner chamber.

13. The tape and reel apparatus of claim 10 further comprising a valve fluidly connected between the fluid pump and the port.

14. The tape and reel apparatus of claim 14 wherein the valve is a Venturi Valve.

15. The tape and reel apparatus of claim 10 further comprising a cut-off valve fluidly connected between the fluid pump and the port.

16. The tape and reel apparatus of claim 10 further comprising a regulator fluidly connected between the fluid pump and the port.

17. A method of cleaning a tape and reel carrier tape comprising:
unspooling a tape and reel carrier tape from a first reel and onto a second reel;
as the tape and reel carrier tape travels from the first reel to the second reel, passing the tape and reel carrier tape through an inner chamber of a contaminant removal apparatus; and
removing contaminants from the tape and reel carrier tape by circulating air within an inner chamber of the contaminant removal apparatus.

18. The method of claim 17 wherein the removing contaminants is performed using a fluid pump.

19. The method of claim 17 wherein the passing the tape and reel carrier tape through the inner chamber includes guiding the tape and reel carrier tape into the inner chamber through a first opening of a housing of the contaminant removal apparatus and out of the inner chamber through a second opening of the housing of the contaminant removal apparatus.

20. The method of claim 17 further comprising adjusting a tape width adjustment mechanism within the inner chamber to accommodate a width of the tape and reel carrier tape.
